(19) United States
(12) Patent Application Publication
(10) Pub. No.: US 2026/0327962 A1
(43) Pub. Date: Oct. 22, 2026

(54) IN-SINK CONTAINER RINSER

(71) Applicant: Delta Faucet Company, Indianapolis, IN (US)

(72) Inventors: Randy L. Schneider, II, Carmel, IN (US); Robert Woock, Noblesville, IN (US); Rebecca Magirl, Hendersonville, TN (US)

(21) Appl. No.: 19/468,527

(22) Filed: Feb. 3, 2026

Related U.S. Application Data
(60) Provisional application No. 63/754,456, filed on Feb. 5, 2025.

(51) Int. Cl. E03C 1/184; A47L 15/00; B05B 1/14; E03C 1/04; E03C 1/05; F16K 31/06

(52) U.S. Cl. CPC E03C 1/184; A47L 15/0086; A47L 15/0092; B05B 1/14; E03C 1/04; E03C 1/057; F16K 31/06; E03C 2001/0417

(57) ABSTRACT

A container rinsing apparatus for a sink basin includes a sink flange and/or a stopper that selectively plugs a drain tube of the sink basin. The sink flange and/or the stopper includes a water discharge member having a plurality of nozzles. A user-operable control device, such as a pushbutton, selectively fluidly connects the water discharge member to a supply of water.

### CROSS-REFERENCE TO RELATED APPLICATION

The present application claims priority to U.S. Provisional Patent Application Serial No. 63/754,456, filed Feb. 5, 2025, the disclosure of which is expressly incorporated herein by reference.

### BACKGROUND AND SUMMARY OF THE DISCLOSURE

The present invention relates generally to a fluid dispensing system and, more particularly, to a vessel rinsing apparatus for use with containers, such as pots and pans.

Washing pots and pans may be time consuming and difficult, especially when cookware is coated with dried or baked-on food. Although glass/cup rinsers are known, such glass/cup rinsers are typically mounted on the countertop near the faucet and not capable of washing large containers, such as pots and pans.

The illustrative container rinser of the present disclosure is located at the bottom of the sink and is capable of washing large containers such as pots and pans. The container rinser may include a kitchen sink drain with integrated, high-powered sprays that make it faster and easier to loosen and wash off food debris from pots and pans. The kitchen sink drain of the present disclosure may include multiple integrated, high-powered sprays that make it faster and easier to loosen and wash off food debris when a pot, pan, cup, or other container is placed over the drain activator and pressed down.

The illustrative container rinser of the present disclosure may be a sink drain with built-in, high-powered jets to loosen and pre-rinse food debris from cookware. To operate the container rinser, dirty cookware may be placed over the sprayer and a button on the sink may be pressed to activate powerful sprays. An integrated sensor may identify when the rinser is covered to prevent accidental activation. Like a typical drain, the rinser may also be closed to fill up the sink basin when needed. The rinser is powered by water pressure and may be available in an array of finishes to coordinate with any kitchen sink and/or faucet.

According to an illustrative embodiment of the present disclosure, a container rinsing apparatus for a sink basin includes a stopper that selectively plugs a drain tube of the sink basin. The stopper includes a water discharge member having a plurality of nozzles. A user-operable control device, such as a pushbutton, selectively fluidly connects the water discharge member to a supply of water.

According to another illustrative embodiment of the present disclosure, a container rinsing apparatus for a sink basin includes a stopper that selectively plugs a drain tube of the sink basin. The stopper includes a water discharge member having a plurality of nozzles. A user-operable control device is manually movable between a first position and a second position. A container presence detector senses whether a container is in a space above the stopper. A valve fluidly connects the water discharge member to a supply of water only if the user-operable control device is in the first position, and the container presence detector senses that a container is in the space above the stopper.

According to yet another illustrative embodiment of the present disclosure, a container rinsing apparatus for a sink basin includes a stopper that selectively plugs a drain tube of the sink basin. The stopper includes a water discharge member having a plurality of nozzles. A valve has an open position in which the water discharge member is fluidly connected to a supply of water, and a closed position in which the water discharge member is fluidly disconnected from the supply of water. A user-operable control device selectively moves the valve between the open position and the closed position.

According to a further illustrative embodiment of the present disclosure, a container rinsing apparatus for a sink basin includes an annular sink flange defining a drain of the sink basin. The sink flange includes an internal chamber and a plurality of nozzles in fluid communication with the internal chamber. A user-operable control device is configured to selectively fluidly connect the internal chamber of the sink flange to a supply of water. Illustratively, the user-operable control device may be a mechanical pushbutton diverter. The sink flange is illustratively configured for coupling to a garbage disposal.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description of exemplary embodiments when taken in conjunction with the accompanying drawings, wherein:

FIG. 1 is an upper perspective view of an illustrative container rinsing apparatus shown mounted at the bottom of a sink basin and below a faucet;

FIG. 2 is another upper perspective view of the container rinsing apparatus of FIG. 1 with a pot being positioned for rinsing;

FIG. 3 is an enlarged upper perspective view of the container rinsing apparatus of FIG. 1 in a rinsing mode of operation;

FIG. 4 is a schematic diagram of the container rinsing apparatus of FIG. 1;

FIG. 5 is a schematic side view of another embodiment of an illustrative container rinsing apparatus; and

FIG. 6 is a top view of the sink flange of the container rinsing apparatus of FIG. 5.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

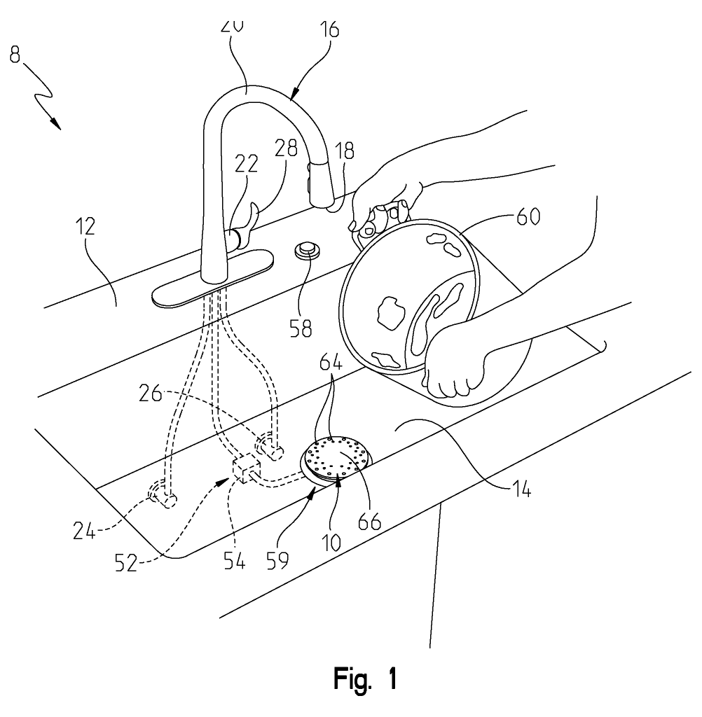

With reference initially to FIG. 1, an illustrative rinsing system 8 of the present disclosure includes a container or pot rinsing apparatus 10 shown supported by a conventional sink basin 14. A faucet 16 may be supported by the sink deck 12 for discharging water from a water outlet 18 into the sink basin 14. The faucet 16 may be of conventional design, including a delivery spout 20 defining the water outlet 18, and a manual mixing valve 22 for controlling water flow from a hot water supply 24 (e.g., a hot water valve stop) and a cold water supply 26 (e.g., a cold water valve stop) to the water outlet 18. The mixing valve 22 may be of conventional design and includes a valve handle 28 to control the flow rate and the temperature of water from the hot water supply 24 and the cold water supply 26 delivered to the water outlet 18.

A manually actuatable pushbutton 58 may be used to control whether a supply of pressurized water is provided to a drain sprayer 59 of the container rinsing apparatus 10. Illustratively, the pushbutton 58 is supported by the sink deck 12 and wired to a flow control device 52 to control the flow of water from the hot water supply 24 and/or cold water supply 26 (illustratively, via the mixing valve 22) to the container rinsing apparatus 10. Alternatively, the pushbutton 58 may be supported in other locations. In certain illustrative embodiments, the pushbutton 58 may be in wireless communication with the flow control device 52.

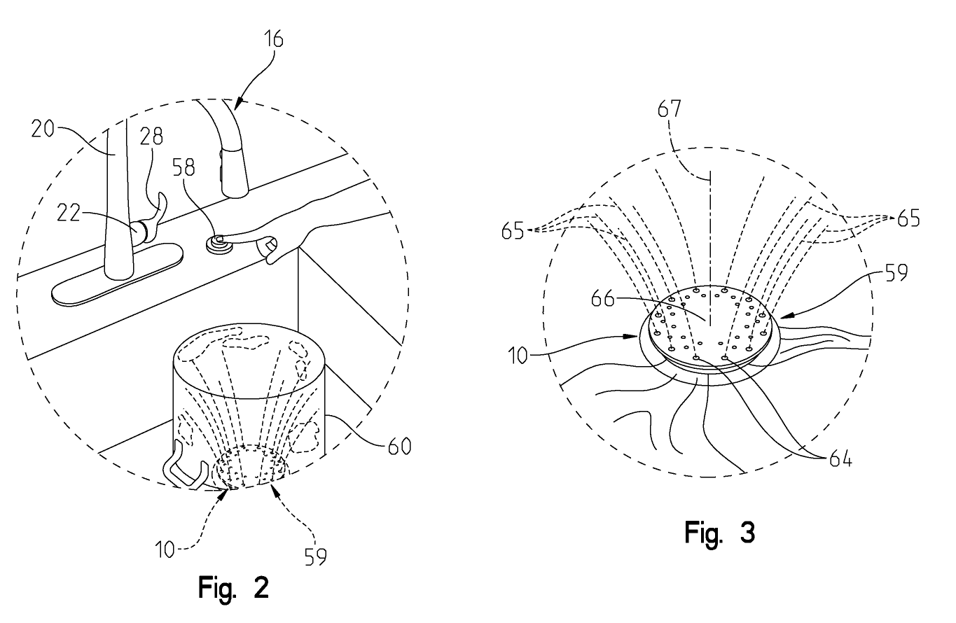

FIG. 2 illustrates the container rinsing apparatus 10 of FIG. 1 with a container, illustratively a pot 60, being positioned for rinsing. That is, a user has manually placed pot 60 over container rinsing apparatus 10. A user is pressing down on pushbutton 58, illustratively with her index finger in order to fluidly connect container rinsing apparatus 10 with a supply of pressurized water such that water is ejected from nozzles 64 of stopper 66, as shown in FIG. 3. Nozzles 64 may be formed as individual check valves such that water may flow upwardly through nozzles 64, as shown by flow lines 65 in FIG. 3, but water cannot flow in the opposite direction through nozzles 64. Thus, stopper 66 may be used to sealingly plug the sink basin 14 without water leaking out of the sink basin 14 through nozzles 64. Some, or possibly all, of nozzles 64 may be directed in directions that diverge from a longitudinal axis 65 of stopper 66. Thus, water 65 may be sprayed over a surface area of the pot that is greater than the surface area of stopper 66. Axis 67 may also be a longitudinal axis of drain tube 12.

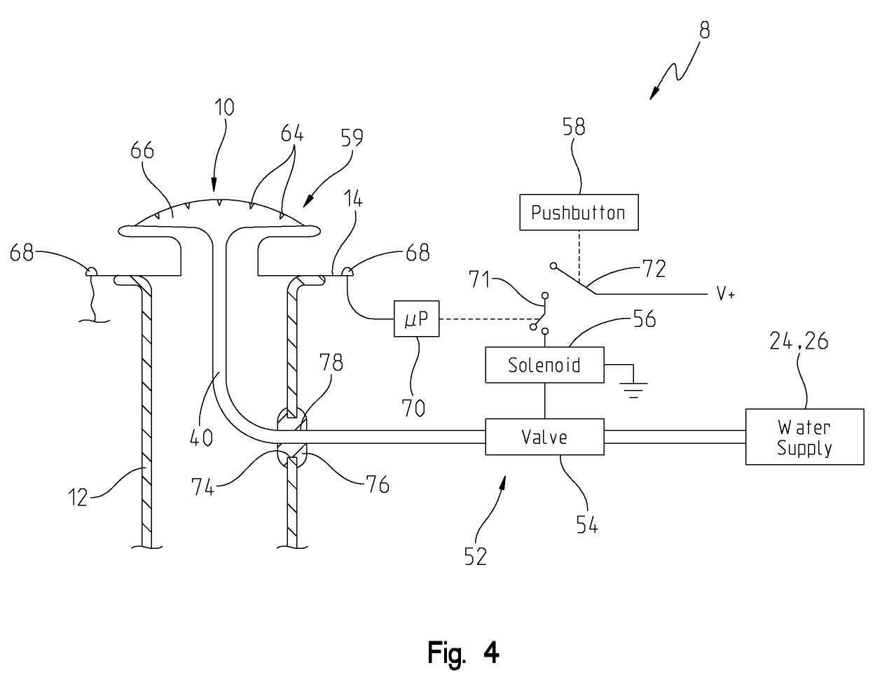

FIG. 4 illustrates other components of the illustrative rinsing system 8 in addition to the container rinsing apparatus 10. Container rinsing apparatus 10 is selectively fluidly connected to a water supply by the flow control device 52. The illustrative flow control device 52 includes a valve 54 operably coupled to an actuator, illustratively a solenoid 56. The water supply may be a hot water supply 24 and/or a cold water supply 26, or a mixture of hot water and cold water as controlled by the mixing valve 22. The solenoid 56 controls whether valve 54 is in an open position such that container rinsing apparatus 10 is fluidly connected to the water supply 24, 26, or is in a closed position such that container rinsing apparatus 10 is fluidly disconnected from the water supply 24, 26. Solenoid 56, in turn, is controlled by a user interface, such as the pushbutton 58 that selectively connects solenoid 56 to electrical power V+ or disconnects solenoid 56 from electrical power V+.

A container presence detector including sensors 68 may be mounted in the sink basin 14, as shown in FIG. 4, on the vertical walls of the sink basin 14, on faucet 16, or on stopper 66, for example. The container presence detector 68 may detect the presence of a container (e.g., a pot or pan) above the container rinsing apparatus 10. The container presence detector 68 may use any conventional technology, such as infrared, ultrasonic waves, or radar to detect movement and presence of a pot or pan above the pot rinsing apparatus 10.

The sensors 68 of the container presence detector may transmit their output signals to an electronic processor 70, which may analyze the output signals and determine therefrom whether there is a container above the container rinsing apparatus 10. Processor 70 may then, in conjunction with pushbutton 58, selectively connect solenoid 56 to electrical power V+ or disconnect solenoid 56 from electrical power V+. That is, if pushbutton 58 is depressed, and processor 70 detects the presence of a pot/pan above the container rinsing apparatus 10, then switches 71, 72 are both closed, connecting solenoid 56 to V+, and valve 54 is opened to fluidly connect the water supply to the container rinsing apparatus 10.

A sink drain pipe 12 below stopper 66 may include a through-hole 74 having a grommet 76 received therein. Grommet 76 includes a through-hole 78 through which a water dispenser tube 40 extends. One end of the dispenser tube 40 is fluidly connected to the pot rinsing apparatus 10, and the other end of the dispenser tube 40 is fluidly connected to the valve 54.

During use, when a user manually turns on or activates container rinsing apparatus 10 by placing a container, illustratively pot 60, over container rinsing apparatus 10 and pressing down on pushbutton 58, a flow of water flows through dispenser tube 40 to container rinsing apparatus 10. When the pot 60 is placed over container rinsing apparatus 10, sensors 68 detect the pot and processor 70 thereby causes switch 71 to close. When the user presses pushbutton 58, switch 72 is also caused to close, and voltage V+ is then applied to solenoid 56. The application of voltage causes solenoid 56 to activate, and thereby open valve 54. Thus, water flows through valve 54 and eventually reaches the container rinsing apparatus 10 through dispenser tube 40.

If the user no longer wants water to be ejected from the container rinsing apparatus 10, then he may stop pressing pushbutton 58, thereby causing switch 72 to open and voltage V+ to be removed from solenoid 56. Alternatively, the user removing the pot 60 from the space over the container rinsing apparatus 10 may cause switch 71 to open and voltage V+ to be removed from solenoid 56. The removal of voltage causes solenoid 56 to deactivate, and thereby close valve 54. A flow of water can then no longer reach the container rinsing apparatus 10.

The illustrative rinsing system 8 has been described as having a dedicated valve 54 for selectively connecting container rinsing apparatus 10 to a water supply. However, it is also possible within the scope of the invention for a diverter valve (not shown) to control (e.g., toggle between) a pressurized supply of water being selectively connected to the outlet 18 of the delivery spout 20 or to the container rinsing apparatus 10. Use of such a diverter valve would enable the mixing valve 22 to control the mix of hot water and cold water that is delivered to container rinsing apparatus 10. An illustrative diverter valve 36 is detailed in U.S. Pat. No. 8,646,476, the disclosure of which is expressly incorporated by herein by reference.

The illustrative rinsing system 8 has been described as turning on water to the drain sprayer 59 when a separate button 58 is pressed to control water to the drain sprayer 59. However, in an alternative embodiment, instead of the drain sprayer 59 being activated by the separate button 58, there is a valve handle to control water to the drain sprayer 59. In another illustrative embodiment, a container 60 is placed over a drain activator and the container 60 is pressed down on the drain activator to activate the drain sprayer 59. In other words, the drain activator may be similar to the push button 58, but instead of being positioned on the sink deck 12 for activation by the hand of a user, it is positioned in the sink basin 14 for activation by the container 60.

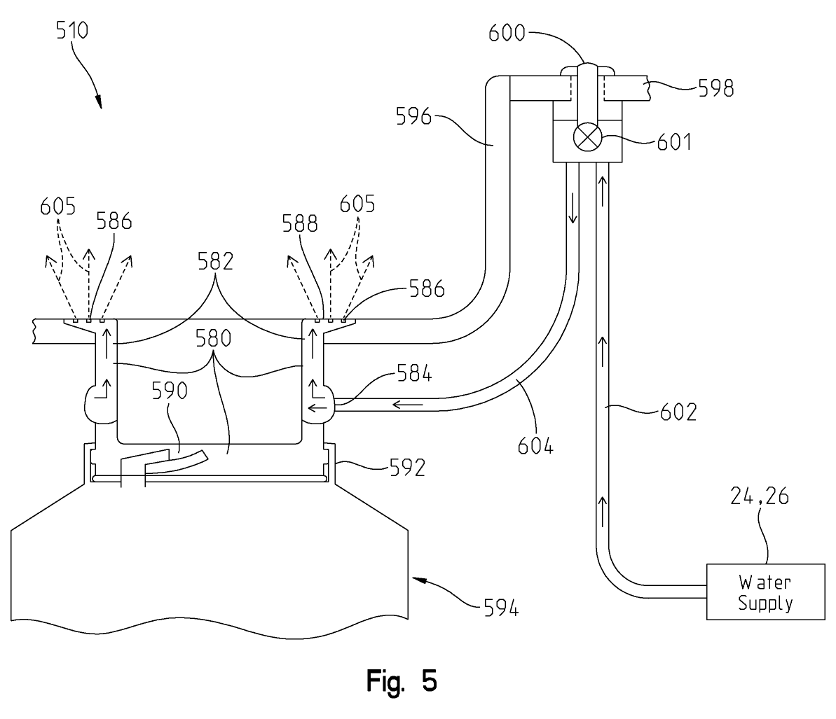

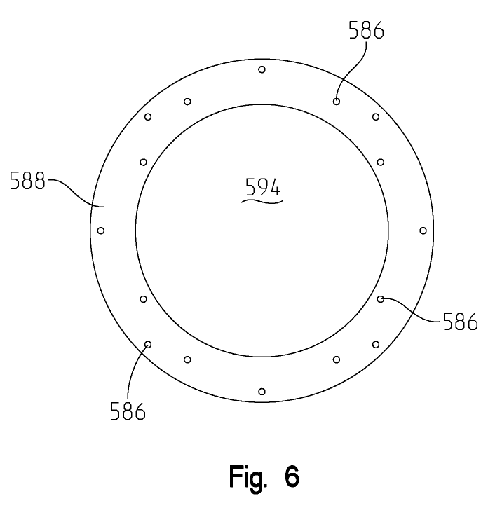

FIG. 5 illustrates another illustrative embodiment of a container rinsing apparatus 510 of the present disclosure, including a sink flange or sink mounting assembly 580 having an internal annular chamber 582 in fluid communication with a water inlet 584 and water outlets or nozzles 586 on its annular top surface 588, which is best shown in FIG. 6. A bottom portion 590 of sink flange 580 may be attached to universal mounting features 592 of a garbage disposal 594. Sink flange 580 is illustratively installed in a sink basin 596 that is mounted in a mounting deck or sink deck 598.

Illustratively, also mounted in the sink basin 596 is a pushbutton diverter 600 with a valve 601 that selectively fluidly connects water inlet 584 to a water supply stop through water supply lines 602 and 604. The pushbutton diverter 600 is illustratively a mechanical design which lowers cost and reduces complexity.

During use, a user places a pot or pan that they would like rinsed over the sink flange 580, and then presses pushbutton diverter 600, thereby opening valve 601 and causing the pressurized water from the water supply stop 24, 26 to flow through line 602, through valve 601, through line 604, and through water inlet 584. The water flows through chamber 582 and is emitted from nozzles 586 (shown by water flow lines 605), thereby rinsing the pot or pan. Nozzles 586 may be oriented in various directions to spray water 605 in different areas of the pot or pan. When the user wants to end the rinsing, they release diverter 600, which closes the valve 601 and stops the water flow from line 602 to line 604.

Instead of annular chamber 582, the sink flange 580 could have a plurality of separate channels each leading to a respective nozzle or a respective group of nozzles. The container rinsing apparatus 510 could include electronics for operation of the pushbutton diverter 600 and/or presence detection of an object covering the drain if desired.

The illustrative embodiment container rinsing apparatus 510 allows for easier water supply attachment (without obscuring the drain outlet) and universal attachment points for a garbage disposal (for dispatching food debris dislodged by the spray nozzles).

Although the invention has been described in detail with reference to certain preferred embodiments, variations and modifications exist within the spirit and scope of the invention as described and defined in the following claims.

What is claimed is:

1. A container rinsing apparatus for a sink basin, the container rinsing apparatus comprising:
a stopper configured to selectively plug a drain tube of the sink basin, the stopper including a water discharge member having a plurality of nozzles; and
a user-operable control device configured to selectively fluidly connect the water discharge member to a supply of water.

2. The container rinsing apparatus of claim 1, wherein the user-operable control device comprises a pushbutton.

3. The container rinsing apparatus of claim 2, wherein the pushbutton is mounted on a mounting deck of a sink that has the sink basin.

4. The container rinsing apparatus of claim 1, further comprising:
a container presence detector configured to sense whether a container is in a space above the stopper; and
an electronic processor configured to:
receive an output signal from the container presence detector; and
dependent upon the output signal, fluidly connect the water discharge member to a supply of water.

5. The container rinsing apparatus of claim 4, further comprising a valve having an open position in which the water discharge member is fluidly connected to the supply of water, and a closed position in which the water discharge member is fluidly disconnected from the supply of water, the user-operable control device being configured to move the valve between the open position and the closed position.

6. The container rinsing apparatus of claim 5, further comprising a solenoid configured for moving the valve between the open position and the closed position, operation of the solenoid being dependent upon both operation of the user-operable control device and operation of the electronic processor.

7. A container rinsing apparatus for a sink basin, the container rinsing apparatus comprising:
a stopper configured to selectively plug a drain tube of the sink basin, the stopper including a water discharge member having a plurality of nozzles;
a user-operable control device manually movable between a first position and a second position;
a container presence detector configured to sense whether a container is in a space above the stopper; and
a valve configured to fluidly connect the water discharge member to a supply of water only if:
the user-operable control device is in the first position; and
the container presence detector senses that a container is in the space above the stopper.

8. The container rinsing apparatus of claim 7, wherein the user-operable control device comprises a pushbutton.

9. The container rinsing apparatus of claim 8, wherein the pushbutton is mounted on a mounting deck of a sink.

10. The container rinsing apparatus of claim 7, further comprising an electronic processor configured to:
receive an output signal from the container presence detector; and
dependent upon the output signal, fluidly connect the water discharge member to a supply of water.

11. The container rinsing apparatus of claim 7, wherein the valve has an open position in which the water discharge member is fluidly connected to the supply of water, and a closed position in which the water discharge member is fluidly disconnected from the supply of water, the user-operable control device being configured to move the valve between the open position and the closed position.

12. The container rinsing apparatus of claim 11, further comprising:
an electronic processor configured to receive an output signal from the container presence detector; and
a solenoid configured for moving the valve between the open position and the closed position, operation of the solenoid being dependent upon both operation of the user-operable control device and operation of the electronic processor.

13. A container rinsing apparatus for a sink basin, the container rinsing apparatus comprising:
a stopper configured to selectively plug a drain tube of the sink basin, the stopper including a water discharge member having a plurality of nozzles;
a valve having:
an open position in which the water discharge member is fluidly connected to a supply of water; and
a closed position in which the water discharge member is fluidly disconnected from the supply of water; and
a user-operable control device configured to selectively move the valve between the open position and the closed position.

14. The container rinsing apparatus of claim 13, wherein the user-operable control device comprises a pushbutton.

15. The container rinsing apparatus of claim 14, wherein the pushbutton is mounted on a mounting deck of a sink that has the sink basin.

16. The container rinsing apparatus of claim 13, further comprising:
a container presence detector configured to sense whether a container is in a space above the stopper; and
an electronic processor configured to:
receive an output signal from the container presence detector; and
dependent upon the output signal, move the valve to the open position.

17. The container rinsing apparatus of claim 16, further comprising a solenoid configured for moving the valve between the open position and the closed position, operation of the solenoid being dependent upon both operation of the user-operable control device and operation of the electronic processor.

18. The container rinsing apparatus of claim 13, wherein a majority of the nozzles are directed in directions that diverge from a longitudinal axis of the stopper.

19. A container rinsing apparatus for a sink basin, the container rinsing apparatus comprising:
an annular sink flange defining a drain of the sink basin, the sink flange including an internal chamber and a plurality of nozzles in fluid communication with the internal chamber; and
a user-operable control device configured to selectively fluidly connect the internal chamber of the sink flange to a supply of water.

20. The container rinsing apparatus of claim 19, wherein the user-operable control device comprises a pushbutton.

21. The container rinsing apparatus of claim 20, wherein the pushbutton is mounted on a mounting deck of a sink that has the sink basin.

22. The container rinsing apparatus of claim 19, further comprising a valve having an open position in which the internal chamber is fluidly connected to the supply of water, and a closed position in which the internal chamber is fluidly disconnected from the supply of water, the user-operable control device being configured to move the valve between the open position and the closed position.

23. The container rinsing apparatus of claim 19, wherein the nozzles are in an annular top surface of the sink flange.

24. The container rinsing apparatus of claim 19, wherein the sink flange is configured to be attached to a garbage disposal.
